(19) United States
(12) Patent Application Publication
(10) Pub. No.: US 2008/0025909 A1
(43) Pub. Date: Jan. 31, 2008

(54) Continuous process for producing titanium tetrachloride

(76) Inventors: Ling Zhou, Severna Park, MD (US); Frederick E. Schneider, Baltimore, MD (US)

Correspondence Address: KING & SPALDING, 1185 AVENUE OF THE AMERICAS, NEW YORK, NY, 10036-4003, US

(21) Appl. No.: 11/491,335

(22) Filed: Jul. 21, 2006

(51) Int. Cl. C01G 23/02

(52) U.S. Cl. 423/492

(57) ABSTRACT

The invention is a continuous process for producing titanium tetrachloride having a vanadium content of less than 5 ppm.

### FIELD OF THE INVENTION

This invention relates to a continuous process for producing titanium tetrachloride having a vanadium content of less than 5 ppm.

### BACKGROUND OF THE INVENTION

The manufacture of titanium dioxide pigment is commercially performed by either the sulfate process or the chloride process. The chloride process first converts titania-containing ores (typically containing high concentrations of TiO₂) to titanium tetrachloride via a carbochlorination reaction. Carbochlorination is a high temperature (800-1200° C.) reaction that is performed in a chlorinator in the presence of chlorine gas and petroleum coke added as a reductant. The chlorinator is typically a fluid-bed reactor, although static bed reactors may also be used.

The carbochlorination reaction produces titanium tetrachloride in addition to other metal chlorides, which may be volatile or non-volatile at the processing temperature. The vapor-phase (i.e., low boiling point) metal chlorides are separated from the waste non-volatile (i.e., high boiling point) metal chlorides, unreacted ore, and coke in a device such as a cyclone. The vapor mixture is then condensed into a liquid phase crude titanium tetrachloride, which may contain other metal chlorides including aluminium trichloride and vanadium chloride or oxychloride. Processes for removing aluminum chlorides and vanadium (oxy)chlorides are taught in, for example, U.S. Pat. Nos. 4,279,871, 6,562,312 and PCT Int. Appl. WO 2004/063096.

Treatment agents are typically added to the crude titanium tetrachloride in order to complex the impurity metal chlorides which are separated from titanium tetrachloride by one or more distillation methods. Vanadium chloride and oxychloride, which have the closest boiling points to titanium tetrachloride, are then typically separated from the crude titanium tetrachloride with a vanadium treatment agent (such as oils, esters, amines, activated carbon, hydrogen, hydrogen sulfide and metals such as iron or copper). The complexed vanadium compounds are separated from the titanium tetrachloride to produce purified titanium tetrachloride.

It is especially important to remove vanadium chloride and oxychlorides from titanium tetrachloride that is used for the production of titanium dioxide pigment. The presence of vanadium chloride and oxychlorides leads to the formation of unwanted colored species in the product titanium dioxide pigment.

In sum, new processes for producing titanium tetrachloride having a minimal vanadium content are required.

### SUMMARY OF THE INVENTION

The invention is a continuous process for producing titanium tetrachloride having a vanadium content of less than 5 ppm based on the amount of titanium tetrachloride. The process comprises first adding a vanadium treatment agent into a crude titanium tetrachloride process stream to produce one or more easy-to-separate vanadium compounds. The vanadium oxytrichloride content in the process stream is then measured in-process, and the rate of addition of the vanadium treatment agent is adjusted to restore or maintain the vanadium content to an amount of less than 5 ppm. Lastly, the easy-to-separate vanadium compounds are separated from titanium tetrachloride to produce purified titanium tetrachloride having a vanadium content of less than 5 ppm.

### DETAILED DESCRIPTION OF THE INVENTION

The continuous process of the invention comprises first adding a vanadium treatment agent into a crude titanium tetrachloride process stream to produce one or more easy-to-separate vanadium compounds.

The crude titanium tetrachloride process stream is produced in the chloride process. The chloride process is well known in the art. See, for example, U.S. Pat. Nos. 2,486,912 and 2,701,179. The chlorination reaction produces a mixed chloride stream that comprises titanium tetrachloride (TiCl₄) in addition to other volatile and non-volatile metal chlorides. Following chlorination, the mixed chloride stream is cooled (typically to about 150-450° C.) in a cooling vessel, such as a cyclone. Low-volatile metal chloride impurities (e.g., iron, manganese, magnesium, and chromium) are condensed in the cooling vessel and separated from the TiCl₄ vapor stream. The TiCl₄ vapor stream is then condensed to a liquid in one or more condensers to produce the crude titanium tetrachloride process stream that is then purified in the continuous process of the invention.

The crude titanium tetrachloride process stream is comprised of a majority of titanium tetrachloride. The crude titanium tetrachloride process stream typically has a vanadium content of approximately 100-3000 ppm V (mainly vanadium oxychloride (VOCl₃)), based on the amount of titanium tetrachloride, and may additionally comprise aluminum, niobium, tantalum, zirconium chlorides. Unreacted ore and coke fines may additionally be present. Preferably, the crude titanium tetrachloride process stream also comprises aluminum trichloride. The presence of aluminum trichloride has been found to increase the rate of vanadium removal in the present invention, while simultaneously reducing the amount of vanadium treatment agent that is necessary for the vanadium removal process.

It is necessary to remove a majority of the vanadium oxychloride that is found in the crude titanium tetrachloride process stream in order to produce titanium tetrachloride that is useful for the production of titanium dioxide pigment. The presence of vanadium oxychloride is known to result in the formation of unwanted colored species in the product titanium dioxide pigment.

The crude titanium tetrachloride process stream is treated with a vanadium treatment agent. The vanadium treatment agent is added into the crude titanium tetrachloride process stream by any suitable addition or mixing method.

Although the process of the invention is not limited by choice of a particular vanadium treatment agent, suitable vanadium treatment agents useful in the invention include, but are not limited to, organic oils, esters, amines, activated carbon, and metal (e.g., Fe, Cu) or non-metal (e.g., H₂, H₂S) reductants. Preferred organic oils include petroleum oil, an animal fat, a vegetable oil, hydrogenated naphthenic oil (including severely hydrotreated heavy naphthenic distillate), and mixtures thereof. Particularly preferred vanadium treatment agents include hydrogenated naphthenic oils, such as Hyprene L1200 (a product of Ergon, Inc.).

The amount of vanadium treatment agent added is based on the amount necessary to reduce the vanadium content in the purified titanium tetrachloride to less than 5 ppm. Preferably, the amount of vanadium treatment agent added is 0.8 to 1.2 times the stoichiometric quantity required to react with the vanadium oxytrichloride to be removed from the crude titanium tetrachloride process stream. More preferably, the amount of vanadium treatment agent is from 0.95 to 1.1 times the stoichiometric requirement.

The vanadium treatment agent reacts with the vanadium oxytrichloride in the crude titanium tetrachloride process stream to produce one or more easy-to-separate vanadium compounds in the process stream. The easy-to-separate vanadium compounds are typically solids or other compounds that are much less volatile than titanium tetrachloride and are thus easy to separate by a variety of different processes. Separation processes include distillation, adsorption, filtration, decantation, centrifuge and the like.

Following the addition of vanadium treatment agent, the vanadium oxytrichloride content in the crude titanium tetrachloride process stream is measured in-process. The measurement is performed by an optical method such as transmission filter Infrared spectroscopy, transmission Fourier Transform Infrared spectroscopy, Raman spectroscopy, Attenuated Total Reflectance Infrared spectroscopy, or Attenuated Total Reflectance Fourier Transform Infrared spectroscopy. Preferably, the measurement is performed by transmission Fourier Transform Infrared spectroscopy. The presence of vanadium oxychloride is detected by an adsorption band at about 1034 cm⁻¹ which correlates with the V═O stretching in VOCl₃.

Based upon the amount of vanadium oxychloride detected in the in-process measurement, the rate of addition of the vanadium treatment agent is then adjusted to restore or maintain the vanadium content to an amount of less than 5 ppm vanadium based on the amount of titanium tetrachloride. For example, if the vanadium content in the process stream is measured at greater than 5 ppm, the amount of vanadium treatment agent will be increased to bring the vanadium content to less than 5 ppm. If the vanadium content in the process stream is measured at less than 5 ppm, the amount of vanadium treatment agent will be maintained (or may even be decreased) to maintain the vanadium content at less than 5 ppm. The in-process measurement and adjustment insures that vanadium treatment agent is used in only the quantity that is necessary to maintain the desired vanadium content.

Lastly, the easy-to-separate vanadium compounds are separated from the titanium tetrachloride to produce purified titanium tetrachloride having a vanadium content of less than 5 ppm. Any of the conventional apparatus and methods for separating the easy-to-separate vanadium compounds from the titanium tetrachloride may be used. Preferably, the separation process is a distillation, filtration, centrifugation, or a solid-liquid separation process.

The purified titanium tetrachloride produced in the process of the invention may be used in the production of titanium dioxide pigment.

The following examples merely illustrate the invention. Those skilled in the art will recognize many variations that are within the spirit of the invention and scope of the claims.

### EXAMPLE 1

### Titanium Tetrachloride Purification Procedure

The effluent from a chlorinator reactor (50-60 wt. % TiCl₄, 1000-3000 ppm VOCl₃, 40-50 wt. % others, including impurity metal chlorides, unreacted ore and coke, and non-condensable gases) is cooled by passing the effluent into a cyclone. The chlorinator effluent is cooled to a temperature within a range of 180-300° C. The cyclone is cooled by a TiCl₄ spray. The solid and liquid waste (containing unreacted ore and coke, ferrous chloride, manganese chloride, magnesium chloride, and chromium chloride) is separated from the vapor product, and the vapor product is taken overhead in the cyclone and passed to a first stage quench tower maintained at a temperature of from 60-90° C. The majority of TiCl₄ is condensed in the tower and passed to a surge tank. Any vapor phase TiCl₄ is passed to a second and third stage condenser which condenses the remaining TiCl₄ and passes it to a crude TiCl₄ tank. As the surge tank is filled, it overflows into the crude TiCl₄ tank.

Vanadium treatment agent (Ergon, Inc. Hyprene L 1200) is added to the surge tank. The presence of AlCl₃ will catalyze the reactions between vanadium compounds and the treatment agent, which results in faster reaction and less treatment agent requirement. At the same time, the reaction product between the vanadium compounds and the treatment agent will partially or fully passivate AlCl₃ depending on the AlCl₃ and vanadium concentration in the TiCl₄. The unreacted AlCl₃, if any, along with NbCl₅, ZrCl₄, and TaCl₅ will then be passivated in the crude TiCl₄ tank where H₂O/steam is added. The vanadium concentration is monitored on-line by FTIR in the surge tank and crude TiCl₄ tank. Adjustment for vanadium treatment agent amount in the surge tank will be based on the vanadium concentration. An immediate vanadium treatment agent addition can be made in the existing port after the reboiler if ever the situation arises.

### EXAMPLE 2

### Vanadium Oxychloride Conversion

Analytical grade vanadyl trichloride (VOCl₃, 0.96 g) is added to pure TiCl₄ (683 g) in a 3-necked flask containing a magnetic stir bar, resulting in a TiCl₄ solution containing 1406 ppm VOCl₃. The flask is fitted with a thermometer connected to a calcium chloride drying tube, a polytetrafluoroethylene plastic gland with a rubber septum through which reactants can be added and samples withdrawn, and a second polytetrafluoroethylene plastic gland with a rubber septum through which two Teflon tubes are fit to circulate the reaction mixture to a flowcell of a FTIR (ASI, Columbia, Md.). The reaction mixture is circulated through the FTIR flowcell while being heated to 100° C. by a heating mantle. When the temperature stabilizes, Hyprene L1200 (950 microliters) is added to the mixture under agitation. Gradual decrease of VOCl₃ peak at 1034 cm⁻¹ is observed. After 257 minutes, a 10-mL sample is withdrawn via syringe through the septum. The sample is transferred to a dry centrifuge tube and centrifuged. A sample of the clear liquid is analyzed to show 165 ppm V.

### EXAMPLE 3

### Vanadium Oxychloride Conversion in the Presence of Aluminum Chloride

The procedure of Example 2 is repeated with the exception that analytical grade aluminum trichloride (3.38 g) is additionally added with VOCl₃ (0.915 g) to pure TiCl₄ (724 g), resulting in a TiCl₄ solution containing 1264 ppm VOCl₃. Also, only 550 microliters of Hyprene L1200 is added to the mixture under agitation.

In the presence of aluminum trichloride, the VOCl₃ peak at 1034 cm⁻¹ is immediately reduced. After 60 minutes, a 10-mL sample is withdrawn via syringe through the septum. The sample is transferred to a dry centrifuge tube and centrifuged. A sample of the clear liquid is analyzed to show ≦10 ppm V.

This example shows that the presence of aluminum trichloride aids the reduction of vanadium content in a TiCl₄ solution. The amount of the Hyprene vanadium treatment agent is reduced by almost half compared to Example 2, yet the reaction rate has increased significantly resulting in appreciably lower vanadium content.

1. A continuous process for producing titanium tetrachloride having a vanadium content of less than 5 ppm, based on the amount of titanium tetrachloride, comprising:
(a) adding a vanadium treatment agent comprising an organic oil into a crude titanium tetrachloride process stream to produce one or more easy-to-separate vanadium compounds in the process stream; said crude titanium tetrachloride pocess stream comprising titanium tetrachloride, vanadium compounds, and aluminum trichloride;
(b) measuring in-process the vanadium content in the process stream;
(c) adjusting the rate of addition of the vanadium treatment agent to restore or maintain the vanadium content to an amount of less than 5 ppm, based on the amount of titanium tetrachloride; wherein said aluminum trichloride catalyzes the reaction between said vanadium compounds and said vanadium treatment agents; and wherein the reaction product of said vanadium treatment agent and said vanadium compounds partially or fully passivates said aluminum trichloride; and
(d) separating the easy-to-separate vanadium compounds from the titanium tetrachloride process stream to produce purified titanium tetrachloride having a vanadium content of less than 5 ppm.

2. (canceled)

3. The process of claim 1 wherein the vanadium treatment agent is selected from the group consisting of a petroleum oil, an animal fat, a vegetable oil, hydrogenated naphthenic oil, and mixtures thereof.

4. The process of claim 1 wherein the vanadium treatment agent is a hydrogenated naphthenic oil.

5. (canceled)

6. The process of claim 1 wherein the in-process measurement is performed by transmission Fourier Transform Infrared spectroscopy.

7. The process of claim 1 wherein the separation process is selected from the group consisting of distillation, a solid-liquid separation process, filtration, and centrifugation.
